(19) United States
(12) Patent Application Publication
(10) Pub. No.: US 2025/0040533 A1
(43) Pub. Date: Feb. 6, 2025

(54) Fumigation Device

(71) Applicants: Michael Todd Szymczak, Boring, OR (US); Lindaway Keys Szymczak, Boring, OR (US)

(72) Inventors: Michael Todd Szymczak, Boring, OR (US); Lindaway Keys Szymczak, Boring, OR (US)

(21) Appl. No.: 18/365,983

(22) Filed: Aug. 5, 2023

(51) Int. Cl. A01M 13/00

(52) U.S. Cl. CPC A01M 13/006

(57) ABSTRACT

Burrowing rodents and other burrowing pests are particularly difficult to eradicate, especially around household pets that like to dig up the rodent mounds in pursuit of the animal. This gas distribution device and the method for using the device was invented to increase the effectiveness of introducing a poisonous or repellent gas into the subterranean tunnels created by burrowing animals such as but not limited to mice, gophers, moles, rats, voles, and various insects. The distribution device can deliver large amounts of poisonous or repellent gas into the subterranean tunnels through the gas distribution chamber using supplied air to assist or without the supplied air assistance. By increasing the effectiveness of distributing poisonous gas throughout subterranean tunnels you may eliminate the need to use traps and poisonous bait that could injure a household pet or livestock.

### BACKGROUND

Burrowing rodents and other burrowing pests are particularly difficult to eradicate, especially around household pets that like to dig up the rodent mounds in pursuit of the animal. Prior art methods of burrowing animal extermination include trapping, explosion, and fumigating. This invention improves the effectiveness of fumigating the subterranean tunnels created by the burrowing pest.

### BRIEF DESCRIPTION OF THE INVENTION

This gas distribution device and the method for using the device was invented to increase the effectiveness of introducing a poisonous or repellent gas into the subterranean tunnels created by burrowing animals such as but not limited to mice, gophers, moles, and various insects. The distribution device can deliver large amounts of poisonous or repellent gas into the subterranean tunnels through the gas distribution chamber using supplied air to assist or without the supplied air assistance. By increasing the effectiveness of distributing poisonous gas throughout subterranean tunnels you may eliminate the need to use traps and poisonous bait that could injure a household pet or livestock.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding

FIG. 1 illustrates the front view of the gas distribution device assembly, a ground penetrating stabilizing spike, a supplied air inlet assembly, a distribution exhaust outlet assembly, a device baseplate, a gas distribution chamber, and a gas distribution chamber door latch, according to an embodiment of the present invention.

FIG. 2 illustrates the back of the gas distribution device assembly with a ground penetrating stabilizing spike, a distribution chamber exhaust valve, a distribution chamber air inlet valve, a gas distribution chamber door, and a gas distribution chamber door rear hinge, according to an embodiment.

FIG. 3 illustrates a top of the gas distribution chamber, a chamber door, a chamber door gasket, chamber door latch, and chamber door rear hinge, according to an embodiment.

FIG. 4 illustrates a bottom of the gas distribution device assembly, a ground penetrating stabilizing spike baseplate attachment connection point, and a gas distribution baseplate according to an embodiment.

FIG. 5 illustrates the gas exhaust port penetrating the side of the gas distribution chamber, according to an embodiment.

FIG. 6 illustrates the top of the gas distribution device assembly with the door open, the supplied air inlet plumbing assembly and the gas distribution chamber exhaust plumbing assembly, according to an embodiment.

FIG. 7 illustrates the top of the gas distribution device, gas distribution chamber, the gas distribution chamber door, a gas distribution chamber door gasket, and the gas distribution chamber door latch, according to an embodiment.

FIG. 8 illustrates the supplied air inlet penetrating the side of the gas distribution chamber, according to an embodiment.

FIG. 9 illustrates the gas distribution chamber exhaust hose 928, according to an embodiment.

### DETAILED DESCRIPTION

The gas distribution device will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of gas distribution device examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

This gas distribution device and the method for using the device was invented to increase the effectiveness of introducing a poisonous or repellent gas into the subterranean tunnels created by burrowing animals such as gophers, moles, and various insects. The distribution device can deliver large amounts of a poisonous or repellent gas into the subterranean tunnels through the gas distribution chamber using a supplied air source or without a supplied air source. By increasing the effectiveness of distributing a poisonous or repellent gas into subterranean tunnels you may eliminate the need to use traps and poisonous bait that could injure a household pet or livestock.

The gas distribution device can be operated with or without; a ground penetrating stabilizing spike or supplied air. The operator should decide the best version for their location.

The gas distribution chamber can be loaded with multiple gas sources at one time if desired. Also, the distribution chamber can be reloaded multiple times at the same location to deliver large amounts of a poisonous or repellent gas into the subterranean tunnels by simply opening the distribution chamber door and replacing the depleted gas sources with new ones. This will greatly increase the effectiveness of the poisonous or repellent gas.

The distribution device was designed to protect the operator from harmful gas after the ignition of the gas source while introducing the poisonous or repellent gas into the subterranean tunnels created by burrowing animals such as gophers, moles, and various insects. With the distribution chamber door closed, gas distribution exhaust hoses in place and sealed, and the supplied air inlet connected to a supplied air source or plugged before the poisonous or repellent gas is deployed, the operator is protected from the poisonous or repellent gas escaping the distribution device during operations.

Place the gas distribution device near the burrowing animal's subterranean tunnel, insert the exhaust hoses into the tunnels, establish a low-pressure air seal between the subterranean tunnel and the exterior of the exhaust hoses and open the exhaust valves.

The device can be operated with or without a supplied air source but is much more effective when the supplied air source is used during fumigation. Connect the supplied air source to the supplied air inlet assembly. This connection can be made with a variety of adapters currently available or adapters for future air sources that have not yet been invented.

Ignite the gas source wicks, then place them inside the distribution chamber, and close the chamber door to seal in any poisonous or repellent gas from escaping.

Turn on the supplied air source to move the poisonous or repellent gas throughout the subterranean tunnel system.

If more fumigation is required at a location simply reload the chamber and repeat the ignition process.

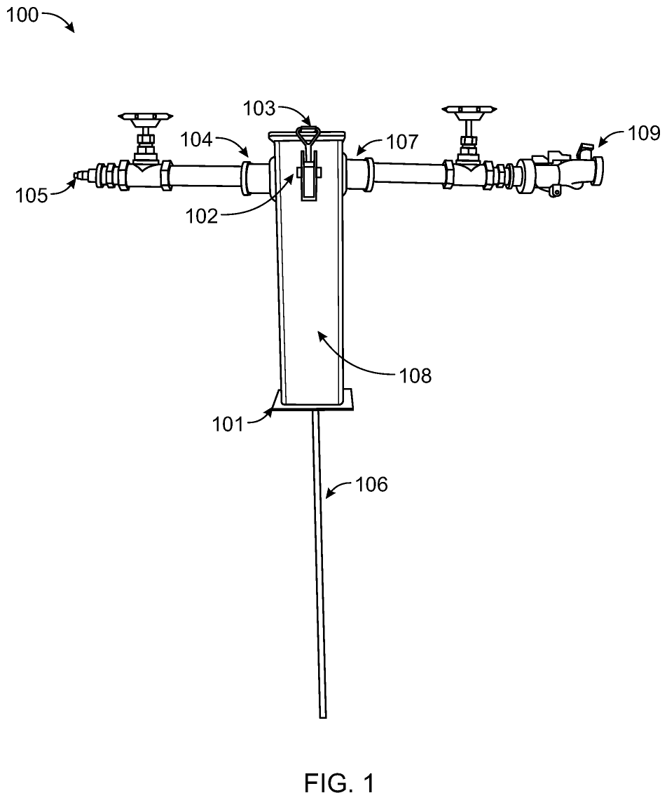

Some of the features in FIG. 1 through FIG. 9 are the same or similar to some of the features as noted by same reference numbers, unless expressly described otherwise.

FIG. 1 illustrates the gas distribution device assembly 100 with a ground penetrating stabilizing spike 106, the supplied air inlet assembly 104 & 105, the gas distribution chamber exhaust port assembly 107 & 109, device baseplate 101, gas distribution chamber 108, and the gas distribution chamber door latch 102 & 103, according to an embodiment of the present invention.

In one embodiment, the gas distribution device assembly 100 may be made out of steel, plastic, ceramics, aluminum, concrete, wood, or a composite of many different materials we have to choose from today or those that haven't been invented yet.

In this embodiment, the baseplate 101 may be differing in length, size & shape due to the differing sized burrowing animal's subterranean tunnels. The baseplate 101 is designed to seal the bottom of the gas distribution chamber during fumigation and supports other components of the gas distribution device.

In one embodiment of the present invention, the gas distribution device assembly 100 can be installed with or without ground penetrating stabilizing spikes 106. For example, in a location where the ground stabilizing spikes are unable to penetrate the surface of the desired location for fumigation, the operator should use a gas distribution device assembly version without the ground penetrating stabilizing spike 106.

In this embodiment, the ground penetrating stabilizing spike 106 is perpendicularly attached to the bottom of the baseplate 419 and is driven into the soil to elevate and stabilize the device during fumigation.

In this example, the ground penetrating stabilizing spike 106 is attached to the bottom of the baseplate 419 and may be different lengths or have different connectors. In this embodiment, the gas distribution device baseplate can be affixed with multiple ground penetration stabilizing spikes 106 to support differing site conditions.

In one embodiment, the supplied air inlet assembly 104 is attached to the outside wall of the distribution chamber 108 and may have different connection methods or moldings. In this example, the gas distribution device will work with or without a supplied air source. In this example, inside the supplied air assembly 104 is an opening 825 penetrating the distribution chamber wall 108, this will allow the supplied air to flow into the distribution chamber and the subterranean tunnel while spreading the poisonous or repellent gas internally. In this embodiment, the supplied air assembly 105 is made up of a variety of fittings that can be adapted for supplied air from many air sources that are available today and air sources that haven't been invented yet.

In one embodiment, the gas distribution chamber 108 is attached to the baseplate 101 and may have different connection methods or moldings. In this example, the distribution chamber 108 may be differing in length, size & shape due to the differing length, size, and shape of gas sources that are currently available today and those that haven't been invented yet.

In this embodiment, the distribution chamber door latch 102 & 103 helps to keep the door closed and sealed during fumigation. In this example the door latch may be differing in length, size & shape or have different connectors.

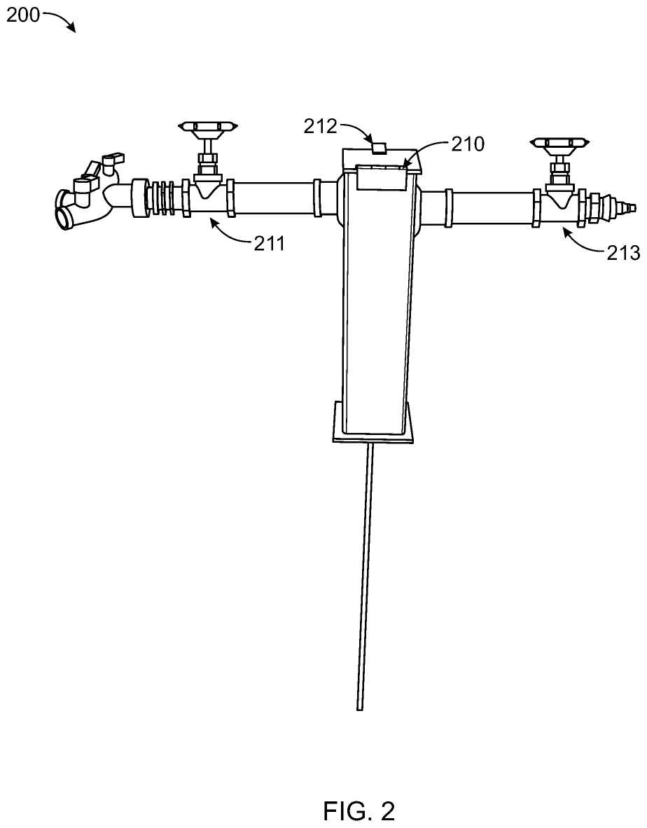

FIG. 2 illustrates the gas distribution device assembly 200 with a ground penetrating stabilizing spike 106, according to an embodiment. In this example, the gas distribution device is equipped with a low pressure air inlet valve 213 and gas distribution chamber exhaust valves 211 & 624, a chamber door 212, and a chamber door rear hinge 210.

In another embodiment, the gas distribution device assembly 200 may be made out of steel, plastic, ceramics, aluminum, concrete, wood, or a composite of many different materials available today or those that have not been invented yet.

In this embodiment, the gas distribution door 212 helps to keep the poisonous or repellent gas from escaping the distribution chamber 108 during fumigation.

in this example, the gas distribution chamber door hinge 210 is attached to the chamber door 212 and the outside gas distribution chamber wall 108. The hinge 209 allows the chamber door 210 to open and close properly.

In one embodiment, the gas distribution chamber supplied air inlet assembly 213 is attached to the outside wall of the distribution chamber 108 and may have different connection methods or moldings.

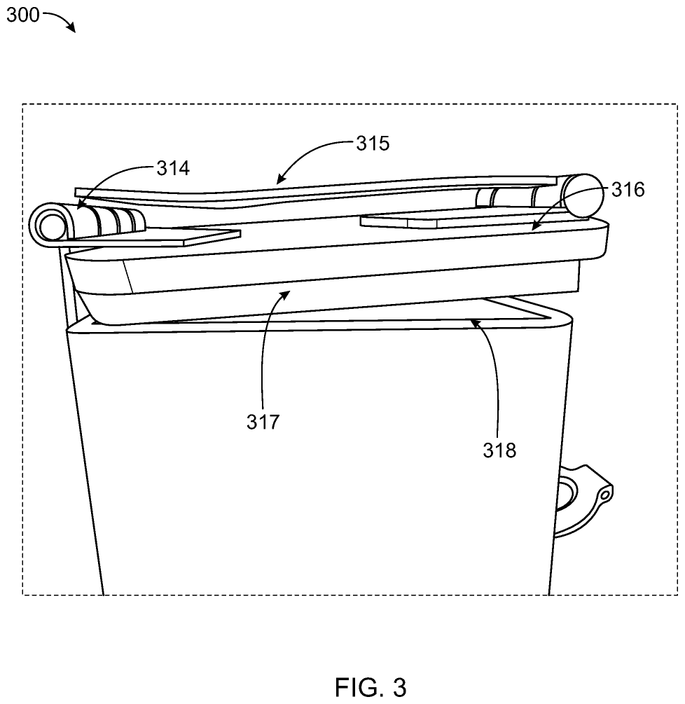

FIG. 3 illustrates the gas distribution chamber door hinge 314, chamber door 316, chamber door gasket 317, chamber door latch 315, and the top of the distribution chamber 318, according to an embodiment.

In this example, the gas distribution chamber door gasket 317 is attached to the distribution chamber door 316 and its purpose is to help create a seal between the chamber door 316 and the top of the distribution chamber 318 during fumigation.

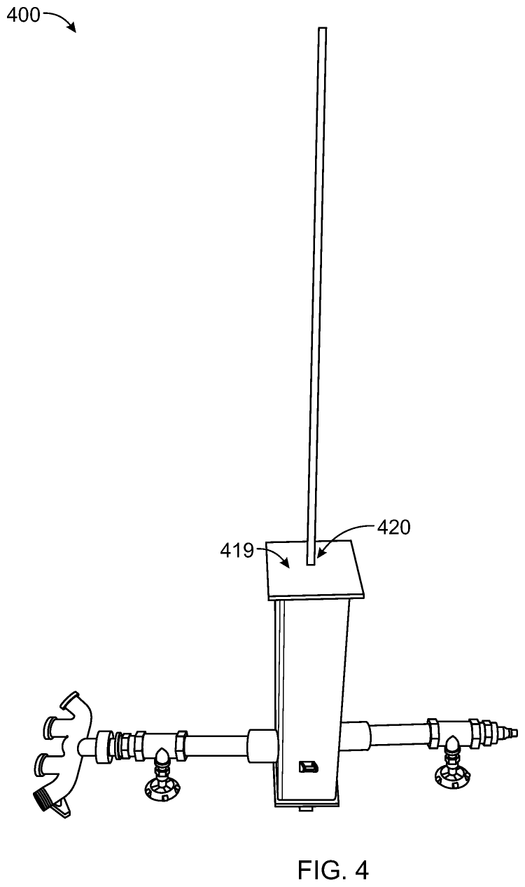

FIG. 4 illustrates the bottom of the gas distribution device assembly 400. The distribution baseplate 419 and the ground penetrating stabilizing spike attachment point 420, according to an embodiment.

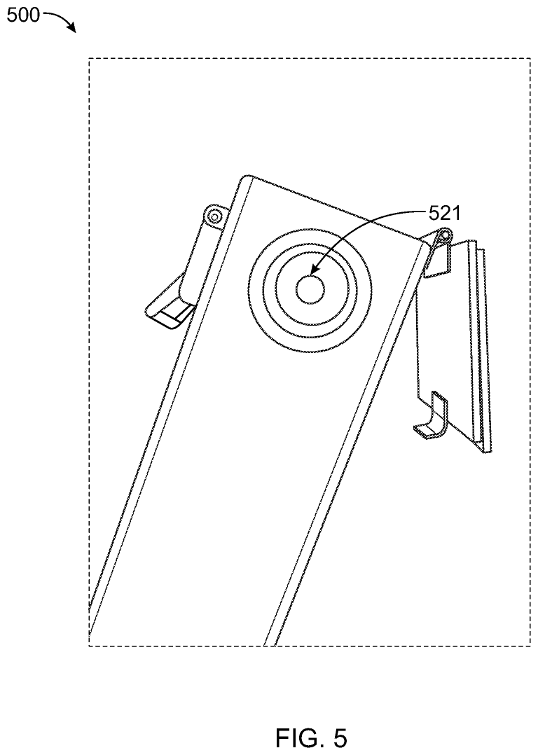

FIG. 5 illustrates the gas distribution chamber 108 and the exhaust port 521 penetrating the side of the gas distribution chamber wall, according to an embodiment. In this example, the exhaust port 521 is an opening passing through the side of the distribution chamber 108 that allow the poisonous or repellent gas to move from the distribution chamber 108 into the burrowing pest subterranean tunnel.

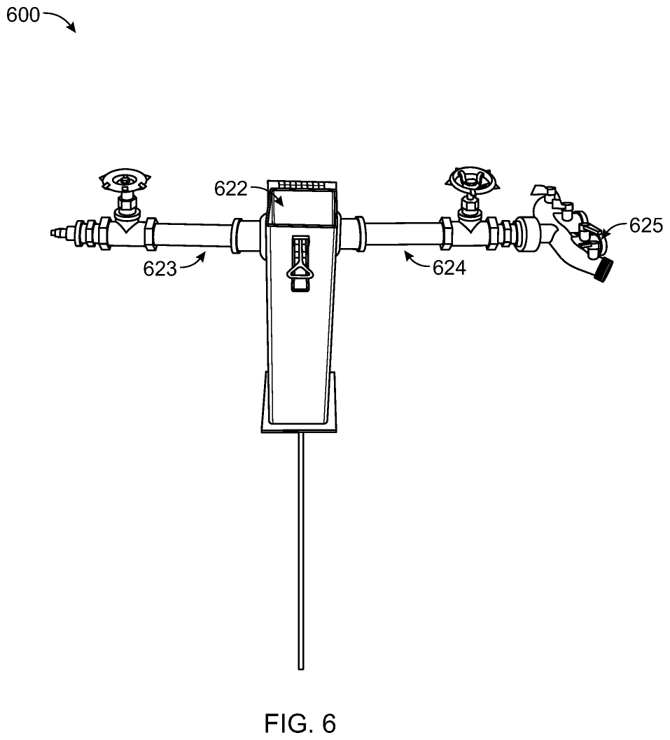

FIG. 6 illustrates the top of the gas distribution device with an open door 622, according to an embodiment. The supplied air inlet plumbing 623, the distribution chamber exhaust plumbing 624, and the exhaust hose valves 625. The exhaust hose valves 625 controls the amount of poisonous or repellent gas that enters each individual subterranean tunnel.

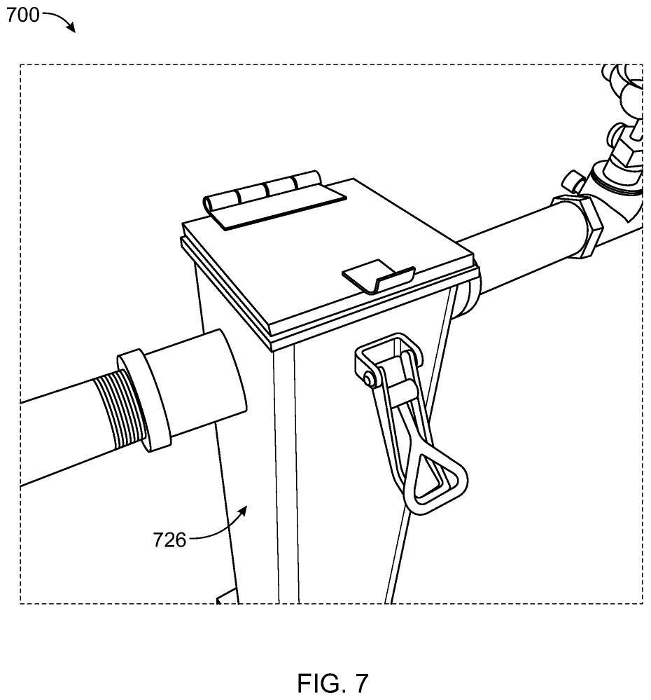

FIG. 7 illustrates the top of the gas distribution device assembly 700 with a closeup view of the gas distribution chamber 726.

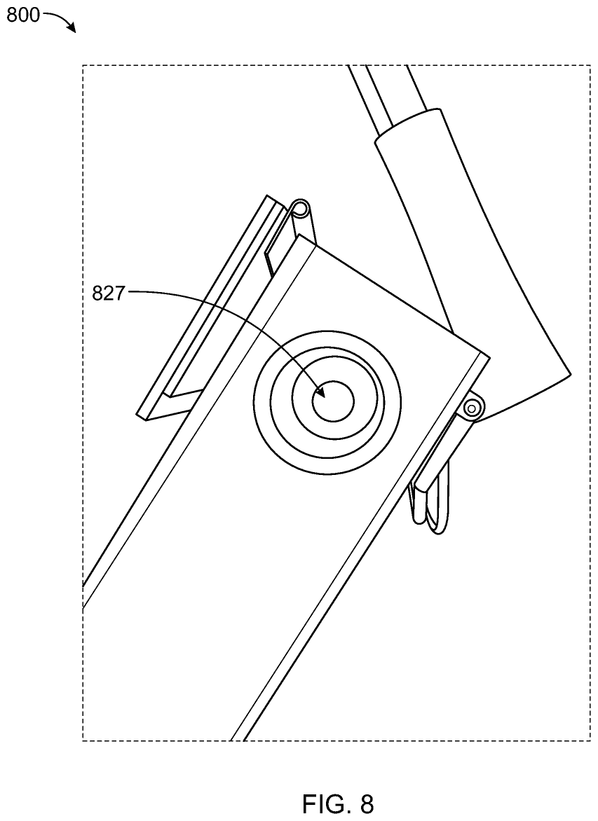

FIG. 8 illustrates the gas distribution chamber 108, the supplied air inlet assembly with the distribution chamber wall air inlet penetration inside 827, according to an embodiment.

In this example, the gas distribution chamber 108, the supplied air inlet assembly 104 with the gas distribution chamber wall air inlet penetration 827, according to an embodiment. The supplied air enters the distribution chamber, mixes with the poisonous or repellent gas inside the distribution chamber 108, and is then forces it out of the chamber through the exhaust port 521 and plumbing 107, 109, 213, 625, & 928 into the subterranean tunnels.

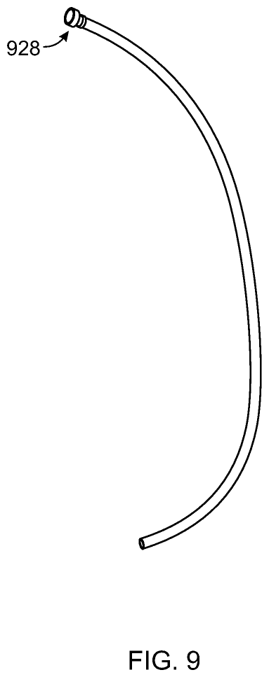

FIG. 9 illustrates the gas distribution chamber exhaust hose 928, according to an embodiment. One end of the exhaust hose attaches to the exhaust hose valve assembly 625, the other end of the hose is inserted into a subterranean tunnel, the operator will create a low pressure air seal between the subterranean tunnel and the outer surface of the exhaust hose before beginning fumigation.

Accordingly, the present invention provides a device and method to perform efficient pest extermination or repellent without the use of an explosive materials, toxic bate, or traps that could expose pets, humans, and livestock to a hazardous environment.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention.

What is claimed is:

1. An apparatus for introducing a poisonous or repellent gas into subterranean tunnels created by burrowing animals such as (but not limited to) mice, gophers, rats, moles, voles, and various insects with or without the assistance of supplied air comprising:
a baseplate designed to seal the bottom of the gas distribution chamber and supports other components of the gas distribution device;
exhaust ports passing through the distribution chamber;
a exhaust port valve assembly;
a exhaust port hose assembly;
a gas distribution chamber that is hollow and will contain a gas source during fumigation;
a chamber door with attached gasket to help create a seal between the chamber door and the top of the distribution chamber during fumigation;
a chamber door hinge that allows the chamber door to open and close properly;
a chamber door latch helps to keep the door closed and sealed during fumigation;
a supplied air inlet assembly attached to the exterior wall of the distribution chamber; and
a air inlet penetrating the wall of the distribution chamber located inside the supplied air inlet assembly.

2. The apparatus of claim 1, wherein the baseplate 101 may be differing in length, size, & shape due to the differing sized burrowing animal's subterranean tunnels.

3. The apparatus of claim 1, wherein the exhaust port 521 penetration is passing through the gas distribution chamber wall that allow the poisonous or repellent gas to move from the distribution chamber into the burrowing pest subterranean tunnel.

4. The apparatus of claim 1, wherein the gas distribution chamber 108 is securely attached to the top of the baseplate 101 through the utilization of diverse connection methods or moldings.

5. The apparatus of claim 1, wherein the gas distribution chamber 108 may be differing in length, size & shape due to the differing length, size, and shape of gas sources that are currently available today and those that haven't been invented yet.

6. The apparatus of claim 1, wherein the chamber door with a attached gasket will help to create a seal between the chamber door and the top of the distribution chamber during fumigation.

7. The apparatus of claim 1, wherein the distribution chamber door latch helps to keep the door closed and sealed during fumigation and may be differing in length, size & shape or have different connectors.

8. The apparatus of claim 1, may be made out of steel, plastic, ceramics, aluminum, concrete, wood, or a composite of many different materials available today or those that have not been invented yet.

9. The apparatus of claim 1, further comprising exhaust hose valves 625 that controls the amount of poisonous or repellent gas that enters each individual subterranean tunnel.

10. The apparatus of claim 1, further comprising a exhaust hose that one end of the hose attaches to the exhaust hose valve assembly 625 and the other end of the hose is inserted into a subterranean tunnel for fumigation.

11. The apparatus of claim 1, wherein the supplied air inlet assembly 104 is attached to the exterior wall of the distribution chamber 108 may have different connection methods or moldings to said chamber and may be made up of a variety of fittings and valves that can be adapted for attaching supplied air from many air sources that are available today and air sources that haven't been invented yet.

12. The apparatus of claim 11, wherein inside the supplied air assembly 104 is an opening 827 penetrating the distribution chamber wall 108, this will allow the supplied air to flow into the distribution chamber and the subterranean tunnel while spreading the poisonous or repellent gas internally.

13. The apparatus of claim 1, wherein the distribution exhaust port assembly 107 is attached to the exterior wall of the distribution chamber 108 may have different connection methods or moldings to said chamber and may be made up of a variety of fittings and valves that are currently available or that haven't been invented yet.

14. The apparatus of claim 13, wherein inside the exhaust port assembly 107 is an opening 521 penetrating the distribution chamber wall 108, this will allow the poisonous or repellent gas to flow through the exhaust port plumbing assembly and hose into the subterranean tunnel spreading the poisonous or repellent gas internally.

15. The apparatus of claim 1, further comprising a ground penetrating stabilizing spike 106, perpendicularly attached to the bottom of the baseplate 419 and is driven into the soil to elevate and stabilize the device during fumigation.

16. The apparatus of claim 1, can be installed and function properly with or without a ground penetrating stabilizing spike or utilizing an air source to move the poisonous gas or repellent into the subterranean tunnel.

17. A method for introducing a poisonous or repellent gas into the subterranean tunnels created by burrowing animals such as gophers, moles, and various insects using supplied air assistance comprising:
A. place the gas distribution device baseplate near an open access to the burrowing animal's subterranean tunnel, insert the exhaust hose into a tunnel and establish a low-pressure air seal between the subterranean tunnel and the outer surface of the exhaust hose;
B. connect the supplied air source to the supplied air inlet assembly;
C. open the exhaust valves;
D. ignite the gas source wicks, then place them inside the distribution chamber, and close the chamber door to seal in any poisonous or repellent gas from escaping;
E. turn on the supplied air source to move the poisonous or repellent gas throughout the subterranean tunnel system; and
F. if more fumigation is required at this location simply reload the chamber and repeat the ignition process.

18. A method for introducing a poisonous or repellent gas into the subterranean tunnels created by burrowing animals such as gophers, moles, and various insects using supplied air assistance comprising:
G. place the gas distribution device baseplate near an open access to the burrowing animal's subterranean tunnel, insert the exhaust hose into a tunnel and establish a low-pressure air seal between the subterranean tunnel and the outer surface of the exhaust hose;
H. connect the supplied air source to the supplied air inlet assembly;
I. open the exhaust valves;
J. close the air inlet valve;
K. ignite the gas source wicks, then place them inside the distribution chamber, and close the chamber door to seal in any poisonous or repellent gas from escaping and;
L. if more fumigation is required at a location simply reload the chamber and repeat the ignition process.
